(19) United States
(12) Patent Application Publication
(10) Pub. No.: US 2024/0423123 A1
(43) Pub. Date: Dec. 26, 2024

(54) LOCKING ASSEMBLY FOR AN ARM OF AN AGRICULTURAL HEADER

(71) Applicant: CNH Industrial America LLC, New Holland, PA (US)

(72) Inventor: Jason R. Coppinger, II, Davenport, IA (US)

(21) Appl. No.: 18/682,751

(22) PCT Filed: Aug. 9, 2022
(86) PCT No.: PCT/US2022/039793

§ 371 Date: Feb. 9, 2024

Related U.S. Application Data
(60) Provisional application No. 63/231,074, filed on Aug. 9, 2021.

(51) Int. Cl. A01D 34/28; A01D 34/04

(52) U.S. Cl. CPC A01D 34/283; A01D 34/04

(57) ABSTRACT

A locking assembly for an arm of agricultural header includes a pin, a bracket coupled to the pin and to a frame of the agricultural header, and a biasing element. The biasing element is configured to engage the pin with the arm in a first position of the bracket to block rotation of the arm relative to the frame and to disengage the pin from the arm in a second position of the bracket to enable rotation of the arm relative to the frame.

### BACKGROUND

The present disclosure relates generally to a locking assembly for an arm of an agricultural header.

A harvester may be used to harvest agricultural crops, such as barley, beans, beets, carrots, corn, cotton, flax, oats, potatoes, rye, soybeans, wheat, or other plant crops. Furthermore, a combine (e.g., combine harvester) is a type of harvester generally used to harvest certain agricultural crops that include grain (e.g., barley, corn, flax, oats, rye, wheat). During operation of the harvester, the harvesting process may begin by removing a plant from a field, such as by using a header. The header may cut the agricultural crops and transport the cut agricultural crops to a processing system of the harvester. The header may include a cutter bar assembly configured to cut a portion of each agricultural crop (e.g., a stalk), thereby separating the cut agricultural crop from the soil. The cutter bar assembly may extend along a substantial portion of a width of the header at a forward end of the header.

### BRIEF DESCRIPTION

In one embodiment, a locking assembly for an arm of an agricultural header includes a pin, a bracket coupled to the pin and to a frame of the agricultural header, and a biasing element. The biasing element is configured to engage the pin with the arm in a first position of the bracket to block rotation of the arm relative to the frame and to disengage the pin from the arm in a second position of the bracket to enable rotation of the arm relative to the frame.

In one embodiment, a frame assembly for an agricultural header includes a frame configured to couple to an arm of the agricultural header and a locking assembly coupled to the frame. The locking assembly includes a pin configured to engage and disengage the arm, a bracket coupled to the pin and to the frame, and a biasing element configured to engage the pin with the arm to block rotation of the arm and to disengage the pin from the arm to enable rotation of the arm.

In one embodiment, an agricultural header includes a frame, an arm configured to rotate relative to the frame, and a locking assembly coupled to the frame. The locking assembly includes a pin, a bracket coupled to the pin and to the frame, and a biasing element configured to engage the pin with the arm to block rotation of the arm and to disengage the pin from the arm to enable rotation of the arm.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester, in accordance with an aspect of the present disclosure;

FIG. 2 is a perspective view of an embodiment of a header that may be employed within the agricultural harvester of FIG. 1, in accordance with an aspect of the present disclosure;

FIG. 3 is a perspective view of a portion of the header of FIG. 2, including a frame, a cutter bar assembly, and arm assemblies that support the cutter bar assembly, in accordance with an aspect of the present disclosure;

FIG. 4 is a perspective view of an embodiment of a locking assembly coupled to the frame of FIG. 3, in accordance with an aspect of the present disclosure;

FIG. 5 is a top view of the locking assembly of FIG. 4, in accordance with an aspect of the present disclosure; and

FIG. 6 is a perspective view of an embodiment of locking assemblies coupled to the frame of FIG. 3 and levers coupled to the locking assemblies, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

An agricultural harvester may include a header having a cutter bar assembly. The cutter bar assembly may include a cutter bar, a stationary blade assembly, and a moving blade assembly. The moving blade assembly may be fixed to the cutter bar, and the cutter bar/moving blade assembly may be driven to oscillate relative to the stationary blade assembly. Each moving and stationary blade assembly may include multiple blades distributed along a width of the respective blade assembly. As the moving blade assembly is driven to oscillate, the blades of the moving blade assembly move relative to the blades of the stationary blade assembly. As the header is moved through the field by the agricultural harvester, a portion of a crop (e.g., the stalk) may enter a gap between adjacent blades of the stationary blade assembly and a gap between adjacent blades of the moving blade assembly. Movement of the moving blade assembly causes a blade of the moving blade assembly to move across the gap in the stationary blade assembly, thereby cutting the portion of the crop. The header may include belts that move the cut crops toward an inlet of an agricultural crop processing system. In some embodiments, the header may include a reel assembly that directs the portion of the crop toward the cutter bar assembly and/or directs the cut crops from the cutter bar assembly toward the belts.

The cutter bar assembly may be flexible along a width of the header. In such cases, the cutter bar assembly may be supported by multiple longitudinally-extending arms distributed along the width of the header. Each arm may be pivotally mounted to a frame of the header, thereby enabling the cutter bar assembly to flex during operation of the agricultural harvester. While the flexible cutter bar assembly is in contact with the soil surface, the flexible cutter bar assembly may follow the contours of the field, thereby enabling a cutting height to be substantially constant along the width of the header. If a greater cutting height is desired (e.g., based on the field conditions, the types of crops being harvested), the header may be raised such that the flexible cutter bar assembly is positioned above the soil surface. In addition, if a substantially rigid cutter bar assembly is desired (e.g., for certain field conditions, for harvesting certain types of crops), the pivoting movement of each arm may be blocked, thereby substantially reducing the flexibility of the cutter bar assembly. For example, a pin may be inserted at each arm to block rotation of the arm and lock the arm in place relative to the frame. In particular, the present embodiments relate to a locking assembly to efficiently insert a pin into each arm, or to efficiently insert multiple pins into multiple arms to reduce the flexibility of the cutter bar assembly and to transition to a substantially rigid cutter bar assembly.

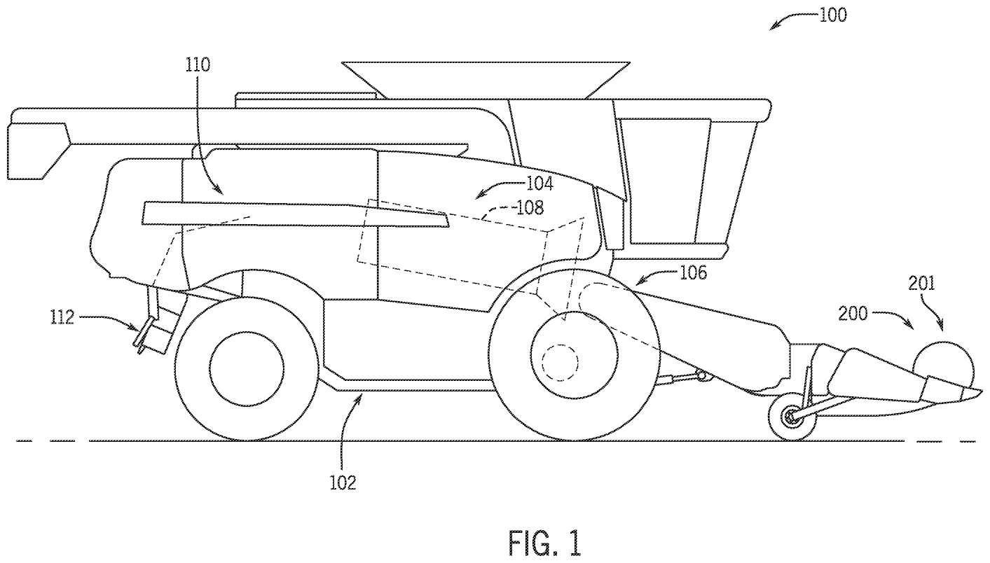

Turning to the drawings, FIG. 1 is a side view of an embodiment of an agricultural harvester 100 having a header 200 (e.g., agricultural header). The agricultural harvester 100 includes a chassis 102 configured to support the header 200 and an agricultural crop processing system 104. As described in greater detail below, the header 200 is configured to cut crops and to transport the cut crops toward an inlet 106 of the agricultural crop processing system 104 for further processing of the cut crops. For example, the header 200 includes a reel assembly 201 configured to direct cut crops toward belts that convey the crops toward the inlet of the agricultural crop processing system 104. In certain embodiments, the reel assembly 201 may be omitted. The agricultural crop processing system 104 receives the cut crops from the header 200 and separates desired crop material (e.g., grain) from crop residue (e.g., husks and pods). For example, the agricultural crop processing system 104 may include a thresher 108 having a cylindrical threshing rotor that transports the cut crops in a helical flow path through the agricultural harvester 100. In addition to transporting the cut crops, the thresher 108 may separate the desired crop material from the crop residue and may enable the desired crop material to flow into a cleaning system located beneath the thresher 108. The cleaning system may remove debris from the desired crop material and transport the desired crop material to a storage compartment within the agricultural harvester 100. The crop residue may be transported from the thresher 108 to a crop residue handling system 110, which may remove the crop residue from the agricultural harvester 100 via a crop residue spreading system 112 positioned at an aft end of the agricultural harvester 100.

As discussed in detail below, the header 200 includes a cutter bar assembly configured to cut the crops within the field. The cutter bar assembly is configured to flex along a width of the header to enable the cutter bar assembly to substantially follow the contours of the field while the cutter bar assembly is engaged with the soil surface. The cutter bar assembly is supported by multiple longitudinally extending arm assemblies distributed along the width of the header. Each arm assembly is pivotally mounted to a frame of the header, thereby enabling the cutter bar assembly to flex. Additionally, each arm assembly may have a range of motion (e.g., float) relative to the frame.

If a substantially rigid cutter bar assembly is desired (e.g., for certain field conditions, for harvesting certain types of crops), the pivoting movement of each arm may be blocked, thereby substantially reducing the flexibility of the cutter bar assembly. In particular, the header 200 may include locking assemblies coupled to the frame of the header 200. Each locking assembly may engage a respective arm in a first position of a bracket of the locking assembly to block rotation of the arm, thereby providing the substantially rigid configuration of the cutter bar assembly. Each locking assembly may include a pin that engages and disengages the arm and a biasing element (e.g., one or more springs) that biases the pin toward or away from the arm. For example, the locking assembly may initially be in a disengaged position with the pin disposed apart from the arm. The locking assembly may transition to an engaged position, such as based on input by a user. In the engaged position, the biasing element biases the pin toward the arm and at least partially through an opening of the arm. After the pin passes at least partially through the opening of the arm, the arm may be blocked from rotating about the frame. In certain embodiments, the pin may pass at least partially through the opening of the arm and a corresponding opening of the frame (e.g., a bracket of the frame) to block rotation of the arm about the frame. Additionally, the bracket of the locking assembly may transition to a second position to disengage the pin from the arm.

In some situations, prior to engagement of the pin with the opening of the arm, the pin and the opening may be misaligned, such that the pin may not pass at least partially through the opening when the locking assembly is transitioned to the engaged position. In certain embodiments, the opening of the arm and a corresponding opening of the frame may be misaligned, such that the pin may not pass at least partially through both openings. After the locking assembly is transitioned to the engaged position, the biasing element may bias the pin toward and against the arm and/or against the frame. The arm may rotate about the frame and move relative to the pin, and the opening of the arm and the pin may align. Once the opening and the pin are aligned, the pin may pass at least partially through the opening without additional input from the user. In embodiments with the frame including the corresponding opening for each arm, the pin, the opening of the arm, and the opening of the frame may align, and the pin may pass at least partially through both of the openings (e.g., in the arm and the frame). Accordingly, the user may not have to align the opening of each arm with corresponding openings of the frame prior to attempting to insert a pin into each arm, such that the locking assemblies described herein may enable the user to more easily and efficiently block rotation of the arms and transition to the cutter bar to the substantially rigid configuration.

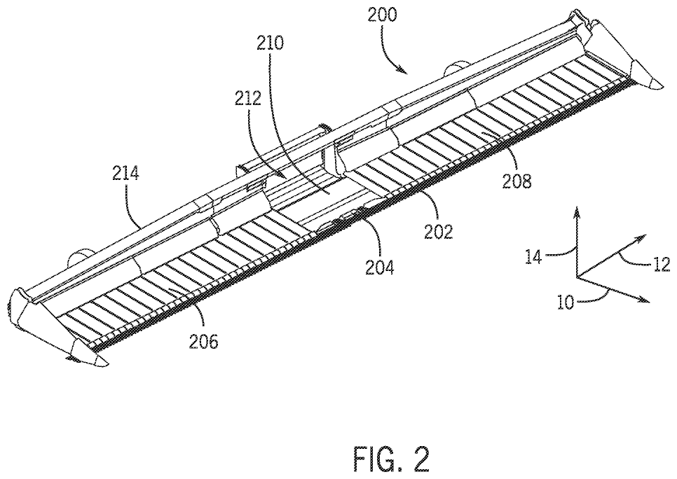

FIG. 2 is a perspective view of an embodiment of the header 200 that may be employed within the agricultural harvester of FIG. 1. In the illustrated embodiment, the header 200 includes a cutter bar assembly 202 configured to cut a portion of each crop (e.g., a stalk), thereby separating the crop from the soil. The cutter bar assembly 202 is positioned at a forward end of the header 200 relative to a longitudinal axis 10 of the header 200 and relative to a direction of travel of the header 200 during harvesting operations. As illustrated, the cutter bar assembly 202 extends along a substantial portion of the width of the header 200 (e.g., the extent of the header 200 along a lateral axis 12). The cutter bar assembly 202 includes a cutter bar, a stationary blade assembly, and a moving blade assembly. The moving blade assembly is fixed to the cutter bar (e.g., above the cutter bar relative to a vertical axis 14 of the header 200), and the cutter bar/moving blade assembly is driven to oscillate relative to the stationary blade assembly. In the illustrated embodiment, the cutter bar/moving blade assembly is driven to oscillate by a driving mechanism 204 positioned at the lateral center of the header 200. However, in other embodiments, the cutter bar/moving blade assembly may be driven by another suitable mechanism (e.g., located at any suitable position on the header). As the agricultural harvester is driven through a field, the cutter bar assembly 202 engages crops within the field, and the moving blade assembly cuts the crops (e.g., the stalks of the crops) in response to engagement of the cutter bar assembly 202 with the crops.

In the illustrated embodiment, the header 200 includes a first lateral belt 206 on a first lateral side of the header 200 and a second lateral belt 208 on a second lateral side of the header 200, opposite the first lateral side. Each belt is driven to rotate by a suitable drive mechanism, such as an electric motor or a hydraulic motor. The first lateral belt 206 and the second lateral belt 208 are driven such that the top surface of each belt moves laterally inward. In addition, the header 200 includes a longitudinal belt 210 positioned between the first lateral belt 206 and the second lateral belt 208 along the lateral axis 12. The longitudinal belt 210 is driven to rotate by a suitable drive mechanism, such as an electric motor or a hydraulic motor. The longitudinal belt 210 is driven such that the top surface of the longitudinal belt 210 moves rearwardly along the longitudinal axis 10. In certain embodiments, the crops cut by the cutter bar assembly 202 are directed toward the belts by a reel assembly. Agricultural crops that contact the top surface of the lateral belts 206, 208 are driven laterally inwardly to the longitudinal belt 210 due to the movement of the lateral belts 206, 208. In addition, agricultural crops that contact the longitudinal belt 210 and the agricultural crops provided to the longitudinal belt 210 by the lateral belts 206, 208 are driven rearwardly along the longitudinal axis 10 due to the movement of the longitudinal belt 210. Accordingly, the belts move the cut agricultural crops through an opening 212 in the header 200 to the inlet of the agricultural crop processing system.

In the illustrated embodiment, the cutter bar assembly 202 is flexible along the width of the header 200 (e.g., the extent of the header 200 along the lateral axis 12). As discussed in detail below, the cutter bar assembly 202 is supported by multiple arm assemblies extending along the longitudinal axis 10 and distributed along the width of the header 200 (e.g., along the lateral axis 12 of the header 200). Each arm assembly is mounted to a frame 214 of the header 200 and configured to rotate about a pivot axis relative to the frame 214. As a result, the cutter bar assembly 202 may flex during operation of the agricultural harvester. The flexible cutter bar assembly 202 may follow the contours of the field while the cutter bar assembly 202 is in contact with the surface of the field, thereby enabling the cutting height (e.g., the height at which each crop is cut) to be substantially constant along the width of the header 200 (e.g., the extent of the header 200 along the lateral axis 12). However, if a substantially rigid cutter bar assembly is desired (e.g., for certain field conditions, for harvesting certain types of crops), the pivoting movement of the arm assemblies may be blocked, thereby substantially reducing the flexibility of the cutter bar assembly 202.

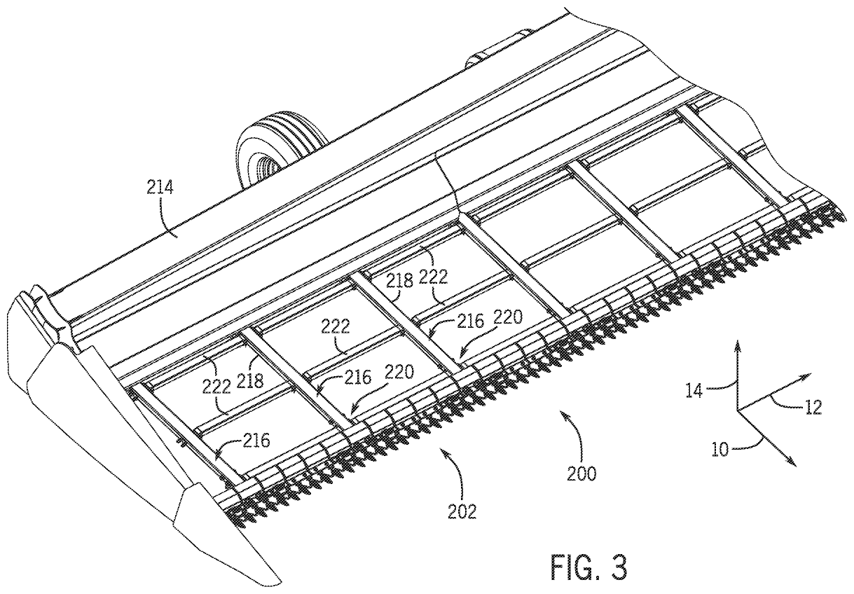

FIG. 3 is a perspective view of an embodiment of a portion of the header 200 of FIG. 2, including the cutter bar assembly 202 and arm assemblies 216 that support the cutter bar assembly 202. As illustrated, each arm assembly 216 extends substantially along the longitudinal axis 10. However, in alternative embodiments, each arm assembly may extend in any suitable direction. In the illustrated embodiment, the arm assemblies 216 are distributed along the width of the header 200 (e.g., the extent of the header along the lateral axis 12). The spacing between the arm assemblies 216 may be selected to enable the arm assemblies 216 to support the cutter bar assembly 202 and to enable the cutter bar assembly 202 to flex during operation of the header 200 (e.g., while the cutter bar assembly 202 is in the flexible configuration).

As discussed in detail below, each arm assembly 216 includes an arm 218 coupled to the cutter bar assembly 202 at an end 220 (e.g., end portion, first end) of the arm 218 and pivotally coupled to the frame 214 at an end (e.g., end portion, second end) of the arm 218 (e.g., a second end opposite the end 220). The coupling between each arm 218 and the frame 214 is a respective pivot joint, and the pivot joint is configured to enable the respective arm assembly 216 to rotate relative to the frame 214 about a respective pivot axis. In the illustrated embodiment, lateral supports 222 extend between adjacent pairs of arms 218. A first end of each lateral support 222 is pivotally coupled to one arm 218, and a second end of each lateral support 222 is pivotally coupled to another arm 218. The lateral supports 222 are configured to support the respective lateral belt, while enabling the arm assemblies 216 to rotate about the respective pivot axes relative to the frame 214. While three lateral supports are positioned between each pair of arms in the illustrated embodiment, in other embodiments, more or fewer lateral supports may be positioned between at least one pair of arms (e.g., 1, 2, 3, 4, 5, 6). Furthermore, in certain embodiments, the lateral supports may be omitted between at least one pair of arms. In certain embodiments, some or all the lateral supports 222 and/or the arms 218 may include slots that enable the lateral supports 222 and the arms 218 to move relative to one another, such as generally along the longitudinal axis 10.

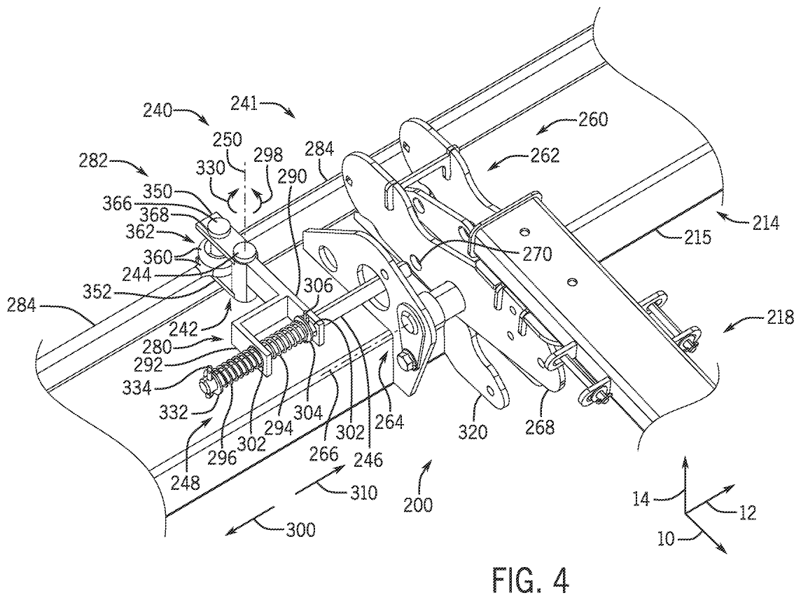

FIG. 4 is a perspective view of an embodiment of a locking assembly 240 of the header 200 coupled to the frame 214. In certain embodiments, a frame assembly 241 of the header 200 may include the frame 214 and the locking assembly 240. The locking assembly 240 is configured to rotate relative to the frame 214 to engage the arm 218 pivotally coupled to the frame 214. While engaged with the arm 218, the locking assembly 240 may substantially block rotation of the arm 218 relative to frame 214, thereby transitioning the cutter bar assembly 202 of FIG. 3 to a rigid configuration. While the locking assembly 240 is disengaged from the arm 218, as shown in FIG. 4, the arm 218 may rotate relative to the frame 214, thereby enabling the cutter bar assembly 202 to flex. The locking assembly 240 may include a bracket 242, a fastener 244 coupling the bracket 242 to a member 215 (e.g., beam) of the frame 214, a pin 246 coupled to the bracket 242, and a biasing element 248 (e.g., spring) coupled to and/or disposed along the pin 246. The locking assembly 240 may rotate/pivot about a pivot axis 250 extending through the fastener 244 (e.g., the locking assembly 240 may rotate about the fastener 244) to engage and disengage the pin 246 with the arm 218. As illustrated, the pivot axis 250 extends parallel to the vertical axis 14 and perpendicular to the longitudinal axis 10 and the lateral axis 12.

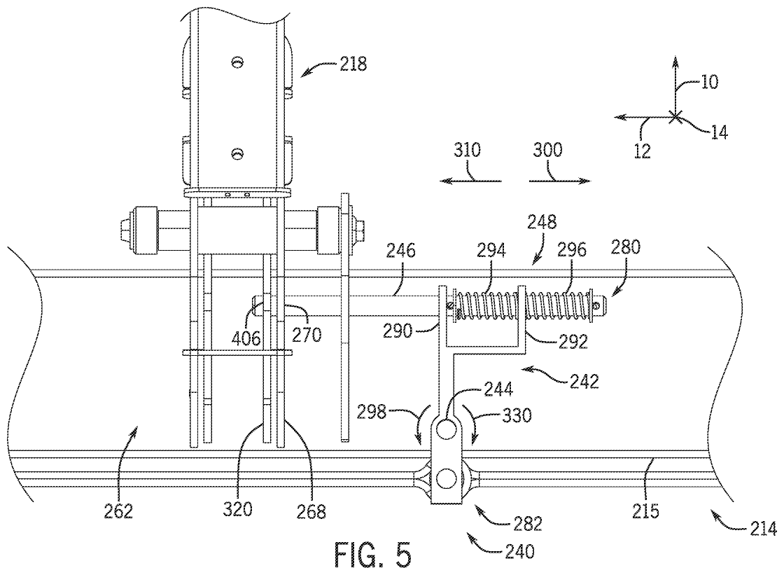

As illustrated, the arm 218 includes an end 260 (e.g., a second end) disposed generally opposite the end 220 shown in FIG. 3 along the longitudinal axis 10. At the end 260, the arm 218 includes a bracket 262 (e.g., the arm 218 and the bracket 262 are rigidly coupled to one another). The bracket 262 is pivotally coupled to the frame 214 at a pivot joint 264, such that the arm 218 is configured to rotate relative to the frame 214 and about a pivot axis 266 extending through the pivot joint 264. As illustrated, the pivot axis 266 extends parallel to the member 215 of the frame 214 and parallel to the lateral axis 12. The bracket 262 includes a side portion 268 (e.g., plate) having an opening 270 (e.g., shown as a through hole, but may be a recess or groove) configured to receive the pin 246. For example, as the bracket 242 of the locking assembly 240 pivots about the pivot axis 250, the pin 246 may move generally along the lateral axis 12 and relative to the opening 270. In FIG. 4, the pin 246 is disposed apart from the opening 270, such that the locking assembly 240 is disengaged from the arm 218 (e.g., a first position of the bracket 242). In FIG. 5, the pin 246 is positioned within the opening 270, such that the locking assembly 240 is engaged with the arm 218 (e.g., a second position of the bracket 242. As illustrated, the opening 270 is circular and generally matches a shape of the pin 246. In other embodiments, the opening in the arm 218 may be a slot in the side portion 268, such as a non-circular or oblong slot extending generally along the longitudinal axis 10. As the locking assembly 240 rotates about the pivot axis 250, the pin 246 may engage the slot to block movement of the arm 218 about the pivot axis 266.

The bracket 242 includes a first end 280 that supports and is coupled to the pin 246 and a second end 282 that is coupled to levers 284. Additionally, the bracket 242 is coupled to the fastener 244 generally between the first end 280 and the second end 282. As illustrated, the first end 280 of the bracket 242 is a yoke having a first arm 290 (e.g., bracket arm or yoke arm) and a second arm 292 (e.g., bracket arm or yoke arm), which may be disposed parallel to one another and generally parallel to the longitudinal axis 10. The pin 246 extends through the first arm 290 and the second arm 292. In other embodiments, the bracket 242 may include only one arm or more than two arms at the first end 280. In some embodiments, the bracket 242 may include other shapes configured to slidably support the pin 246.

The biasing element 248 extends between the first arm 290 and the second arm 292 and to the side of the second arm 292. In particular, the biasing element 248 may include a first biasing member 294 disposed on a first side of the second arm 292 and between the first arm 290 and the second arm 292 (e.g., on a first side of the second arm 292). The biasing element 248 may also include a second biasing member 296 disposed on a second side of the second arm 292 opposite the first side. The first biasing member 294 and/or the second biasing member 296 may be spring(s) that compress and extend as the locking assembly 240 rotates relative to the frame 214 and the arm 218. For example, as the bracket 242 rotates about the pivot axis 250 in a direction 298 (e.g., a first position of the bracket 242), and if the pin 246 is not aligned with the opening 270, the pin 246 may contact the side portion 268 of the bracket 262. When the pin 246 contacts the side portion 268, the pin 246 may be pushed in a direction 300 relative to the bracket 242, such that the pin 246 moves through openings 302 within the first arm 290 and the second arm 292 of the bracket 242. The first biasing member 294 may be compressed between the second arm 292 and a washer 304 of the locking assembly 240. As illustrated, the locking assembly 240 includes a pin 306 (e.g., a cotter pin) extending through the pin 246 that limits movement of the washer 304 relative to the pin 246 in a direction 310 (e.g., a direction opposite the direction 300). In other embodiments, movement of the washer 304 in the direction 310 may be limited by other features of the locking assembly 240, and/or the locking assembly 240 may include other features against which the first biasing member 294 may compress. Compression of the first biasing member 294 may bias the pin 246 in the direction 310 against the arm 218. As the arm 218 rotates about the pivot axis 266, such as during operation of the header 200 and/or movement of header 200 generally, the opening 270 may align with the pin 246. Once aligned, the pin 246 may engage the opening 270 due to compression of the first biasing member 294 and block rotation of the arm 218 relative to the frame 214, thereby transitioning the cutter bar assembly 202 to the rigid configuration.

Additionally, as illustrated, the frame 214 includes a bracket 320 disposed parallel to the side portion 268 of the bracket 262. As explained in greater detail below, the bracket 320 may include an opening for engagement by the pin 246. For example, the opening 270 may align with both the pin 246 and the opening of the bracket 320, and the pin 246 may engage both the opening 270 and the opening of the bracket 320. Engagement of the pin 246 with the opening 270 and the opening of the bracket 320 may block rotation of the arm 218 relative to the frame 214. The pin 246 may remain engaged with the opening 270 and the opening of the bracket 320 due to a weight of the arm 218. For example, the weight may cause the second end 260 of the arm 218 to be biased upwardly away from the bracket 320 of the frame 214, thereby causing the pin 246 to be secured between the bracket 320 and the side portion 268 of the bracket 262. Additionally, the pin 246 may remain engaged with the opening 270 due to a rotational position of the bracket 242 in the direction 298. In certain embodiments, the opening of the bracket 320, and/or the bracket 320 generally, may be omitted, such that engagement of the pin 246 with the opening 270 may be sufficient to block rotation of the arm 218 relative to the frame 214.

To enable rotation of the arm 218 and transition the cutter bar assembly 202 to the flexible configuration, the pin 246 may be removed from the opening 270 and/or the opening of the bracket 320. For example, the locking assembly 240 may rotate in a direction 330, and the pin 246 may move through the openings 302 of the first arm 290 and the second arm 292. Rotation of the bracket 242 in the direction 330 (e.g., to a second position of the bracket 242) may compress the second biasing member 296 between the second arm 292 and a washer 332. As illustrated, the locking assembly 240 includes a pin 334 (e.g., a cotter pin) that limits movement of the washer 332 relative to the pin 246 in the direction 300. In other embodiments, movement of the washer 332 in the direction 300 may be limited by other features of the locking assembly 240, and/or the locking assembly 240 may include other features against which the second biasing member 296 may compress. Compression of the second biasing member 296 may bias the pin 246 in the direction 300 away from the arm 218. During operation of the header 200, such as any operation that causes slight movement of the arm 218 about the pivot axis 266, the pin 246 may loosen between the bracket 320 and the side portion 268 of the bracket 262. Once loosened, the pin 246 may disengage the opening 270 of the side portion 268 and/or the opening of the bracket 320 due to compression of the second biasing member 296, such that the arm 218 is free to rotate relative to the frame 214, thereby transitioning the cutter bar assembly 202 to the flexible configuration.

As illustrated, the locking assembly 240 is coupled (e.g., rotatably coupled) to the levers 284 at the second end 282 of the bracket 242. At the second end 282, the bracket 242 includes a first arm 350 and a second arm 352 extending along the longitudinal axis 10. Each lever 284 includes an eye 360 at an end 362 of each lever 284. The eyes 360 of the levers 284 are disposed generally between the first arm 350 and the second arm 352. Additionally, a pin 366 of the locking assembly 240 is disposed through openings 368 of the first arm 350 and the second arm 352 and through the eyes 360 of the levers 284, such that the pin 366 rotatably couples the levers 284 and the bracket 242. Additionally, as explained in greater detail below, each lever 284 may be coupled to multiple locking assemblies 240, such that movement of one lever 284 (e.g., along the lateral axis 12) may drive movement (e.g., rotation) of multiple locking assemblies 240. For example, an operator may move a particular lever 284 in the direction 300 and cause the locking assembly 240 to rotate about the pivot axis 250 in the direction 298, thereby engaging the pin 246 with the arm 218. Additionally, movement of the particular lever 284 may cause one or more other locking assemblies 240 to rotate and engage other arms 218. Further, because the levers 284 may be connected in series (e.g., the eyes 360 connected via the pin 366), movement of the particular lever 284 may drive movement of other levers 284 and rotation of other locking assemblies 240. As such, the operator may provide a single input (e.g., movement of one lever 284) to rotate multiple locking assemblies 240 into engagement with the arms 218, thereby transitioning the cutter bar assembly 202 to the rigid configuration and/or the flexible configuration. Likewise, the operator may move the particular lever 284 in the direction 310 and cause the locking assemblies 240 to rotate in the direction 330, thereby causing the locking assemblies 240 to disengage the arms 218. As illustrated, the levers 284 extend parallel to the member 215 of the frame 214 and parallel to the lateral axis 12. In other embodiments, the levers may be positioned differently relative to the member 215 and/or the lateral axis 12.

FIG. 5 is a top view of the locking assembly 240 of FIG. 4 engaged with the arm 218. In particular, the pin 246 extends through the opening 270 of the side portion 268 and through an opening 400 (e.g., shown as a through hole, but may be a recess or groove) of the bracket 320. As described above, to transition to the engaged position of FIG. 5 from the disengaged position of FIG. 4, the bracket 242 may rotate in the direction 298 about the fastener 244, such that the pin 246 is biased toward the openings 270 and 400. The first biasing member 294 may compress until the pin 246 extends through the openings 270 and 400, at which point the compression of the first biasing member 294 may be released. In certain embodiments, the first biasing member 294 may remain in compression while engaged with the opening 270 and/or the opening 400. For example, in embodiments with the opening 400 and/or the bracket 320 omitted, the first biasing member 294 may remain compressed to facilitate maintaining engagement of the pin 246 with the opening 270.

Additionally, as described above, to disengage the pin 246 from the openings 270 and 400, the bracket 242 may rotate in the direction 330, such that the pin 246 is biased away from the openings 270 and 400. The second biasing member 296 may compress until the pin 246 moves out of the openings 270 and 400, at which point the compression of the second biasing member 296 may be released. In certain embodiments, the second biasing member 296 may remain in compression while disengaged from the opening 270 and/or the opening 400, such as to maintain the disengaged position of the locking assembly 240 from the arm 218.

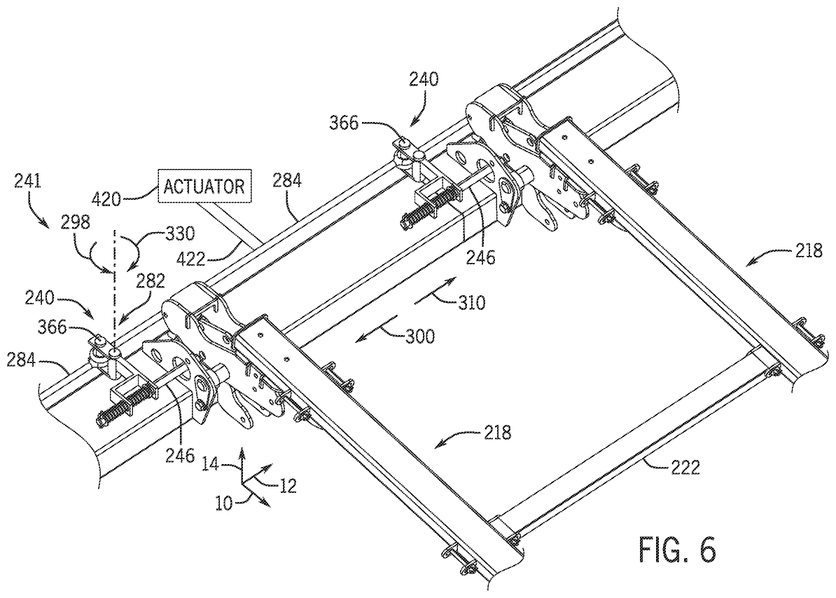

FIG. 6 is a perspective view of an embodiment of the locking assemblies 240 and the levers 284 coupled to the locking assemblies 240. As shown, each lever 284 is coupled to two locking assemblies 240. In other embodiments, each lever 284 may be coupled to more than two locking assemblies 240. Additionally, the header 200 may include a separate or dedicated locking assembly 240 for each arm 218 to facilitate transitioning between the flexible and rigid configurations of the cutter bar assembly 202, or may include a separate or dedicated locking assembly 240 for only some of the arms 218 to facilitate transitioning between the flexible and rigid configurations of the cutter bar assembly 202. Further, the header 200 may include the levers 284 rotatably coupled to each locking assembly 240 or only some of the locking assemblies 240. In some embodiments, the levers 284 may be omitted from the header 200. In embodiments without the lever 284 coupled to a particular locking assembly 240, such as in embodiments of the header 200 without the levers 284, an operator may manually rotate the second end 282 of the particular locking assembly 240 in the direction 298 to engage the particular locking assembly 240 with the arm 218 and in the direction 330 to disengage the particular locking assembly 240 from the arm 218.

In the illustrated embodiment, the operator may move a particular lever 284 in the direction 300 to rotate the locking assemblies 240 coupled to the particular lever 284 in the direction 298, such as by gripping and moving (e.g., pulling) the particular lever 284, thereby engaging the locking assemblies with the arms 218. Additionally, movement of the particular lever 284 in the direction 300 may drive movement of other levers 284 in the direction 300 and other locking assemblies 240 coupled to the other levers 284 in the direction 298, because the levers 284 are connected in series via the pins 366. Accordingly, the operator may provide a single input (e.g., movement of the particular lever 284, pushing or pulling) to move each of the connected levers 284 and the locking assemblies 240 coupled to the levers 284, thereby facilitating engagement and disengagement of the locking assemblies 240 with the arms 218 and transition of the cutter bar assembly 202 between the rigid and flexible configurations.

Additionally, the header 200 may include an actuator 420 (e.g., an electronic actuator) configured to drive movement of one or more levers 284. As illustrated, the actuator 420 is coupled to the lever 284 via an arm 422 of the header 200 that may be rotatably coupled to the lever 284 and/or the actuator 420. An operator may provide an input for the actuator 420 (e.g., while positioned adjacent to the header 200), such as via a button, touch screen display, or other input mechanism. In response to receiving the input, the actuator 420 may move the levers 284 in the direction 300 to engage the locking assemblies 240 with the arms and transition the cutter bar assembly 202 to the rigid configuration. Likewise, in response to receiving an input, the actuator 420 may move the levers 284 in the direction 310 to disengage the locking assemblies 240 from the arms and transition the cutter bar assembly 202 to the flexible configuration. In certain embodiments, an operator positioned remotely from the header 200, such as in a cab of the agricultural harvester 100 or remotely from the agricultural harvester, may provide the input for the actuator 420. Accordingly, the actuator 420 may facilitate transitioning the cutter bar assembly 202 between the rigid and flexible configurations based on a single input provided by the operator. In certain embodiments, the frame assembly 241 of the header 200 may include the frame 214, one or more of the locking mechanisms 240, one or more of the levers 284, the actuator 420, and/or the arm 422.

Accordingly, a locking assembly for an arm of an agricultural header may include a pin, a bracket slidably coupled to the pin, and a biasing element disposed along the pin. The biasing element may bias the pin toward or away from an arm of the header that supports a cutter bar assembly of the header. For example, the biasing element may initially be in a disengaged position with the pin disposed apart from the arm. The locking assembly may transition to an engaged position, such as based on input by a user, in which the biasing element biases the pin toward the arm and at least partially through an opening of the arm. After the pin passes at least partially through the opening of the arm, the arm may be blocked from rotating about the frame. Because the pin is biased toward and/or against the arm, the opening of the arm and/or an opening of a frame bracket need not be aligned when the pin is first moved toward the engaged position. Once the opening of the arm is aligned with the pin and/or the openings of the arm and the frame bracket are aligned, the pin may engage the openings of the arm and the frame bracket. Accordingly, the user may not have to align the opening of each arm with corresponding openings of the frame prior to attempting to insert a pin into each arm, such that the locking assemblies described herein may enable the user to more easily and efficiently block rotation of the arms and transition to the cutter bar to the substantially rigid configuration.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A locking assembly for an arm of an agricultural header, comprising:
a pin;
a bracket coupled to the pin and to a frame of the agricultural header; and
a biasing element configured to:
engage the pin with the arm in a first position of the bracket to block rotation of the arm relative to the frame; and
disengage the pin from the arm in a second position of the bracket to enable rotation of the arm relative to the frame.

2. The locking assembly of claim 1, wherein the biasing element comprises one or more springs disposed along the pin.

3. The locking assembly of claim 2, wherein movement of the bracket between the first position and the second position is configured to compress and expand the one or more springs.

4. The locking assembly of claim 2, wherein the one or more springs comprise:
a first spring disposed on a first side of a bracket arm of the bracket; and
a second spring disposed on a second side of the bracket arm, wherein the first side is opposite the second side, the first spring is configured to compress in the first position of the bracket, and the second spring is configured to compress in the second position of the bracket.

5. The locking assembly of claim 1, wherein the bracket comprises a yoke having two or more yoke arms, and the pin extends through the two or more yoke arms.

6. The locking assembly of claim 1, wherein the bracket is configured to pivot relative to the frame to move between the first position and the second position.

7. The locking assembly of claim 6, wherein the pin is disposed along a lateral axis extending along the frame, and the bracket is configured to pivot about a pivot axis extending perpendicular to the lateral axis.

8. The locking assembly of claim 1, wherein the bracket is rotatably coupled to a lever configured to couple to one or more other locking assemblies.

9. A frame assembly for an agricultural header, comprising:
a frame configured to couple to an arm of the agricultural header; and
a locking assembly coupled to the frame, wherein the locking assembly comprises:
a pin configured to engage and disengage the arm;
a bracket coupled to the pin and to the frame; and
a biasing element configured to engage the pin with the arm to block rotation of the arm and to disengage the pin from the arm to enable rotation of the arm.

10. The frame assembly of claim 9, wherein the frame comprises:
a member coupled to the arm; and
an additional pin coupled to the member, wherein the locking assembly is coupled to the frame via the additional pin.

11. The frame assembly of claim 9, wherein the biasing element comprises:
a first spring disposed on a first side of a yoke arm of the bracket; and
a second spring disposed on a second side of the yoke arm, wherein the first side is opposite the second side, the first spring is configured to compress in a first position of the bracket, and the second spring is configured to compress in a second position of the bracket.

12. The frame assembly of claim 9, wherein the bracket comprises a yoke having two or more yoke arms, and the pin extends through the two or more yoke arms.

13. The frame assembly of claim 9, comprising a lever rotatably coupled to the locking assembly and one or more other locking assemblies, wherein movement of the lever transitions the locking assembly between engagement and disengagement with the arm and the one or more other locking assemblies between engagement and disengagement with one or more other arms.

14. The frame assembly of claim 13, wherein the frame comprises a member coupled to the arm, and the lever extends along the member.

15. The frame assembly of claim 13, wherein the pin is coupled to a first end of the bracket, and the lever is coupled to a second end of the bracket opposite the first end.

16. The frame assembly of claim 13, comprising an actuator configured to drive the movement of the lever based on a user input.

17. An agricultural header, comprising:
a frame;
an arm configured to rotate relative to the frame; and
a locking assembly coupled to the frame, wherein the locking assembly comprises:
a pin;
a bracket coupled to the pin and to the frame; and
a biasing element configured to engage the pin with the arm to block rotation of the arm and to disengage the pin from the arm to enable rotation of the arm.

18. The agricultural header of claim 17, wherein the arm comprises an additional bracket pivotally coupled to the frame, and the additional bracket comprises an opening configured to receive the pin to engage the pin with the arm.

19. The agricultural header of claim 17, wherein the arm comprises:
a first end coupled to a cutter bar; and
a second end configured to engage and disengage the pin, and the first end is opposite the second end.

20. The agricultural header of claim 17, wherein the arm is configured to pivot about a lateral axis extending parallel to a member of the frame while the pin is disengaged from the arm, and the locking assembly is configured to pivot about a vertical axis extending perpendicular to the member to engage and disengage with the arm.
